(19) United States
(12) Patent Application Publication
(10) Pub. No.: US 2015/0036347 A1
(43) Pub. Date: Feb. 5, 2015

(54) COMPOUND LENS AND LED LIGHT SOURCE DEVICE INCORPORATING THE SAME

(71) Applicant: HON HAI PRECISION INDUSTRY CO., LTD., New Taipei (TW)

(72) Inventors: CHAU-JIN HU, New Taipei (TW); FENG-YUEN DAI, New Taipei (TW); YUNG-LUN HUANG, New Taipei (TW)

(73) Assignee: HON HAI PRECISION INDUSTRY CO., LTD., New Taipei (TW)

(21) Appl. No.: 13/974,031

(22) Filed: Aug. 22, 2013

(30) Foreign Application Priority Data
Aug. 5, 2013 (TW) 102127924

(51) Int. Cl. F21V 5/04; F21K 99/00

(52) U.S. Cl. CPC F21V 5/043; F21K 9/58
USPC 362/268; 362/331

(57) ABSTRACT

A compound lens includes a first lens and a second lens coupled to the first lens. The first lens has a light incident face and a light exit face opposite to the light incident face thereof. The first lens defines a recess at a center of the light exit face thereof. The second lens has a refractive index lower than that of the first lens. The second lens is received in the recess of the first lens and a light incident face of the second lens directly contacts the light exit face of the first lens. A light emitting diode light source device incorporating the compound lens is also provided.

### 1. TECHNICAL FIELD

The present disclosure relates generally to a compound lens and an LED light source device incorporating the compound lens, wherein the LED light source device has an improved light distribution.

### 2. DESCRIPTION OF RELATED ART

LEDs are solid state light emitting devices formed of semiconductors, which are more stable and reliable than other conventional light sources such as incandescent bulbs. Thus, LEDs are being widely used in various fields such as numeral/character displaying elements, signal lights, light sources for lighting and display devices.

A traditional light emitting diode (LED) light source device includes an LED light source and a lens coupled to the LED light source. However, a light distribution of the traditional LED light source device is mostly concentrated at a center axis of the lens while becomes gradually weaker towards a periphery of the lens. Therefore, such an LED light source device is difficult to satisfy the requirements of uniform light distribution.

What is needed therefore is an LED bulb which can overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic view of a compound lens in accordance with a first embodiment of the present disclosure.

FIG. 2 is an inverted, schematic view of the compound lens in FIG. 1.

FIG. 3 is schematic, cross section view of the compound lens, taken along the line in FIG. 1.

FIG. 4 is a schematic, cross section view of an LED (light emitting diode) light source device incorporating the compound lens of FIG. 1.

FIG. 5 is a light intensity distribution pattern of a traditional LED (light emitting diode) light source device in prior art.

FIG. 6 is a light intensity distribution pattern of the LED light source device of FIG. 4.

FIG. 7 is a schematic, cross section view of an LED (light emitting diode) light source device in accordance with a second embodiment of the present disclosure.

### DETAILED DESCRIPTION

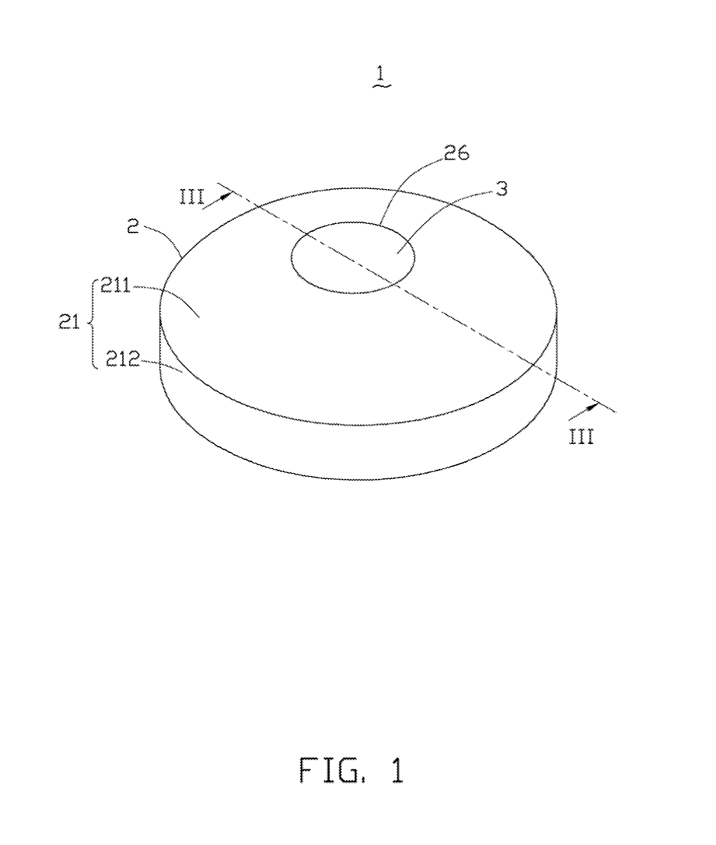

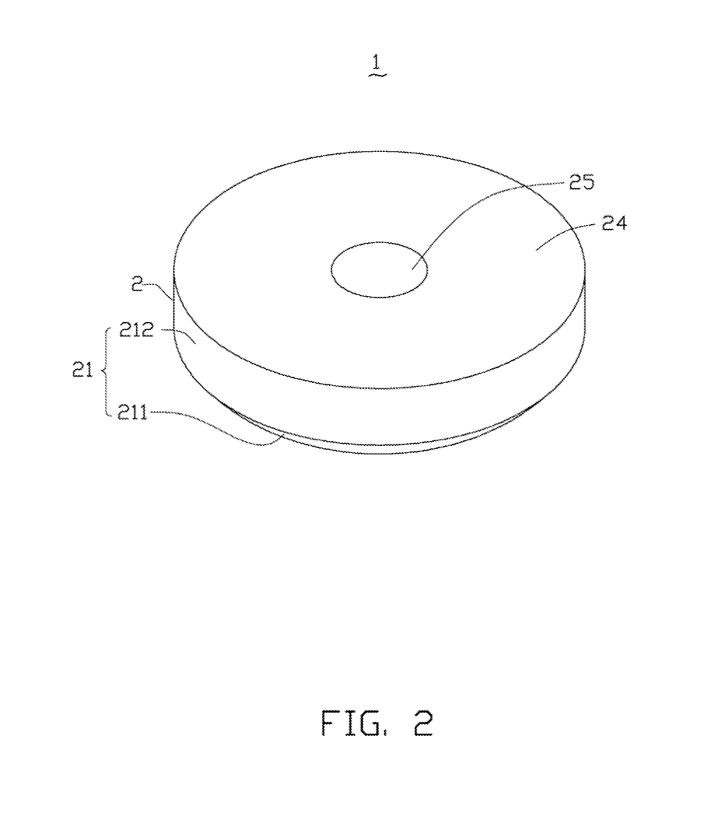

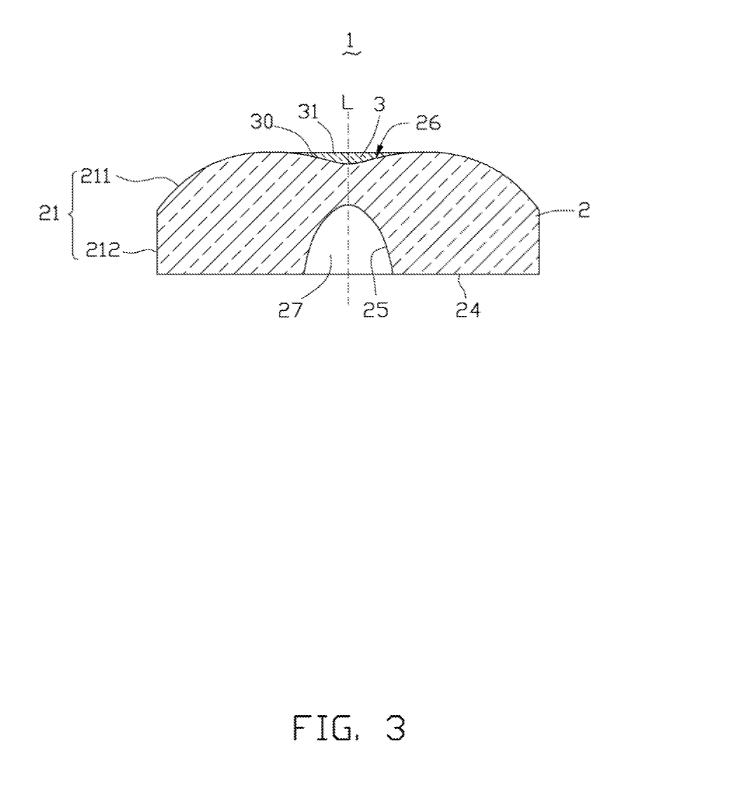

Referring to FIGS. 1, 2 and 3, a compound lens 1 in accordance with a first exemplary embodiment of the present disclosure includes a first lens 2 and a second lens 3 coupled to the first lens 2. The first lens 2 has a light incident face 25 and a light exit face 21 opposite to the light incident face 25. The first lens 2 defines a recess 26 on the light incident face 21 thereof. The recess 26 is recessed inwardly from a center of the light incident face 21 of the first lens 2. The second lens 3 is formed in the recess 26 of the first lens 2 and a light incident face 30 of the second lens 3 is fitly and directly contacts the light exit face 21 of the first lens 2. The second lens 3 has a refractive index lower than that of the first lens 2.

The first lens 2 further includes an annular mounting face 24 interconnecting the light incident face 25 and the light exit face 21 thereof. The light incident face 25 of the first lens 2 is located in a center of the annular mounting face 24 and recessed inwardly from an inner periphery of the annular mounting face 24.

The light exit face 21 of the first lens 2 includes a first cylindrical face 212 extending upwardly from an outer periphery of the annular mounting face 24 and a second convex face 211 bending inwardly from a top periphery of the first cylindrical face 212. The recess 26 is located in a center of the second convex face 211 of the light exit face 21 of the first lens 2. The light incident face 30 of the second lens 3 directly contacts the second convex face 22 of the light exit face 21 of the first lens 2.

The light exit face 21 of the first lens 2 is a convex surface and the light incident face 25 of the first lens 2 is a concave surface. The light exit face 21 and the light incident face 25 of the first lens 2 are symmetric about a common central axis L extending through the first lens 2. In the present embodiment, the light incident face 25 of the first lens 2 is an ellipsoid surface and a semi-major axis of the light incident face 25 is colinear with the central axis L of the first lens 2. In another embodiment, the light incident face 25 of the first lens 2 has a shape of sphere or paraboloid.

A distance between the light exit face 21 and the light incident face 25 of the first lens 2 increases firstly and then gradually decreases along a direction from a periphery of the light exit face 21 of the first lens 2 to a center of the light exit face 21 of the first lens 2. More in details, the distance between the light exit face 21 and the light incident face 25 of the first lens 2 increases firstly and then gradually decreases along a direction from the first cylindrical face 212 of the light exit face 21 towards a center of the second convex surface 211 of the light exit face 21 of the first lens 2.

The second lens 3 covers a portion of the second convex face 211 of the first lens 2. The second lens 3 has a shape matched with that of the recess 26 of the first lens 2. In the present embodiment, the second lens 3 is reversed cone shaped and a diameter of the second lens 3 narrows as it goes downwards. A light exit face 31 of the second lens 3 is connected to the light incident face 30 of the second lens 3. In the present embodiment, the exit face 31 of the second lens 3 is a flat plane. The exit face 31 of the second lens 3 is coplanar with a top portion of the second convex face 211 of the light exit face 21 of the first lens 2.

A distance between the light exit face 31 and the light incident face 30 of the second lens 3 decreases gradually along a direction from a center of the light exit face 21 to a periphery of the light exit face 21 of the first lens 2. More in details, the distance between the light exit face 31 and the light incident face 30 of the second lens 3 decreases gradually from a center of the second convex face 211 of the light exit face 21 towards a first cylindrical face 212 of the light exit face 21 of the first lens 2. That is to say, a thickness of the second lens 3 decreases in a radial outward direction perpendicular to the central axis L of the first lens 2.

The first lens 2 and the second lens 3 are made of transparent or translucent material. In the present embodiment, the first lens 2 is made of a material selected from polycarbonate (PC) resin, polystyrene (PS) resin or methyl methacrylate-styrene (MS) resin. The first lens 2 has a refractive index in a range of 1.57 to 1.59 preferably. The second lens 3 is made of a material selected from polymethyl-methacrylate (PMMA) resin or silicone resin. The second lens 3 has a refractive index in a range of 1.41 to 1.49 preferably.

A method of manufacturing the second lens 3 includes the following steps: filling the recess 26 of the first lens 2 with raw material, such as polycarbonate resin powder; flattening a top face of the raw material with a top portion of the second convex face 212 of the light exit face 21 of the first lens 2 via hot pressing; and exposing the preformed material to an ultraviolet radiation.

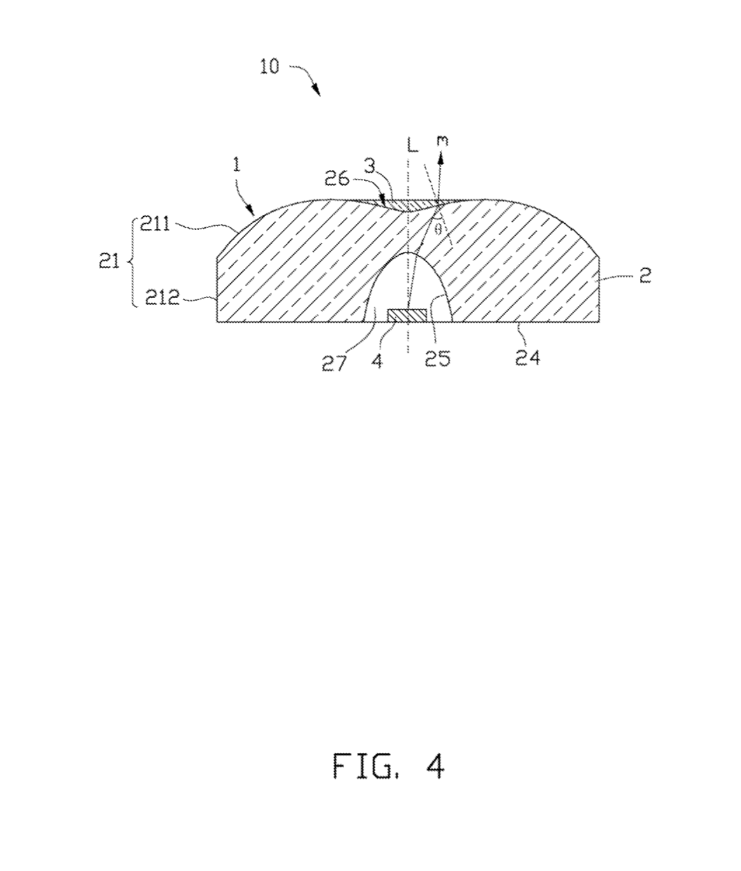

Referring to FIG. 4, an LED light source device 10 incorporating the compound lens 1 of FIG. 1 in accordance with a first exemplary embodiment of the present disclosure includes an LED light source 4 and the compound lens 1 coupled to the LED light source 4. The LED light source 4 faces towards the light incident face 25 of the first lens 2 of the compound lens 1. The mounting face 24 and the incident face 25 of the first lens 2 of the compound lens 1 cooperatively define a receiving space 27 to receive the LED light source 4 therein. An optical axis of the LED light source 4 coincides with the central axis L of the first lens 2.

A light ray m emitted from the LED light source 4 is refracted into the first lens 2 and propagates towards a second convex face 211 of the light exit face 21 of the first lens 2. The light ray m is likely to be reflected at the lens-air interface due to total internal reflection. In the present embodiment, the second lens 3 has a refractive index of 1.49. The first lens 2 has a refractive index of 1.57 larger than that of the second lens 3. A critical angle θ1 for total reflection at the interface between the first lens 2 and air is 39.57 degrees while a critical angle θ0 for total reflection at the interface between the first lens 2 and the second lens 3 is 71.63 degrees.

The second lens 3 is reversed cone shaped. The light ray m hits the interface between the first lens 2 and the second lens 3 at an angle θ. The light incident angle θ increases along a direction from a center of the light exit face 21 of the first lens 2 towards a periphery of the light exit face 21 of the first lens 2. That is to say, the light incident angle θ increases in a radial outward direction perpendicular to the central axis L of the first lens 2. The maximum light incident angle θ (max) between an optical axis of the LED light source 4 and a periphery of the light exit face 31 of the second lens 3 is larger than the critical angle θ1 for total reflection at the interface between the first lens 2 and air.

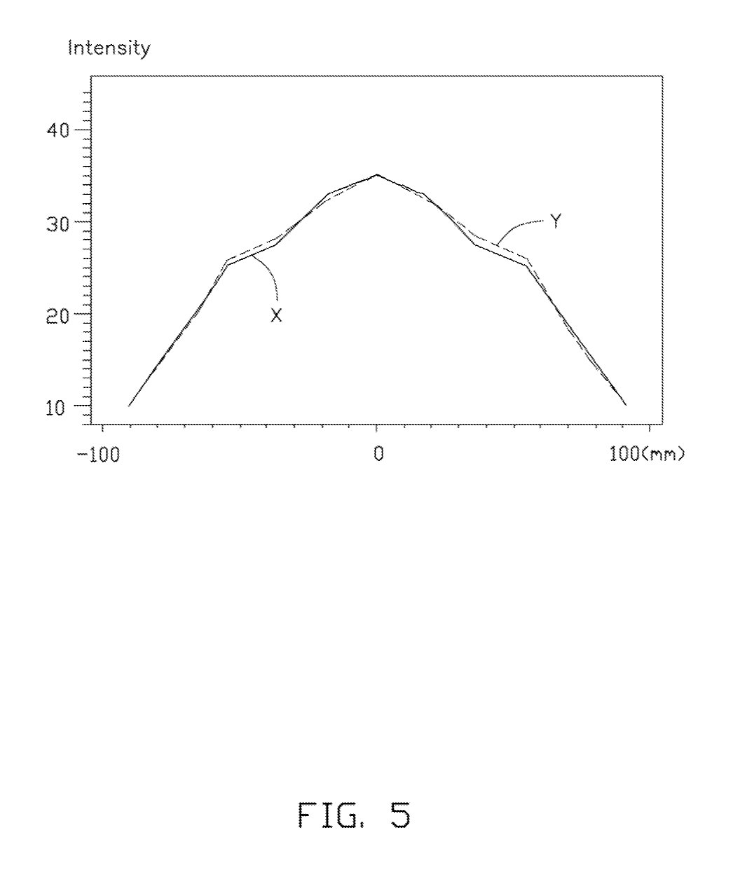

Referring to FIG. 5, a light intensity distribution pattern of a traditional LED light source device in prior art is shown. X-axis shown in FIG. 5 represents a distance between a measuring point and an optical axis of an LED light source of the traditional LED light source device in a first direction of a observed surface, while Y-axis represents a distance between a measuring point and an light optical axis of the LED light source in a second direction perpendicular to the first direction of the observed surface, wherein θ millimeter means where an optical axis of the LED light source of the traditional LED light source device is located on the observed surface.

As the traditional LED light source device only includes the LED light source and a first lens coupled to the LED light source, the incident light that has an incident angle θ larger than the critical angle θ1 for total reflection at the interface between the first lens and air is reflected back into the first lens due to total internal reflection. That is to say, the incident light that has an incident angle θ larger than 39.57 degrees is reflected back into the first lens, which reduces light intensity in an annular zone around a center of the first lens as shown in FIG. 5.

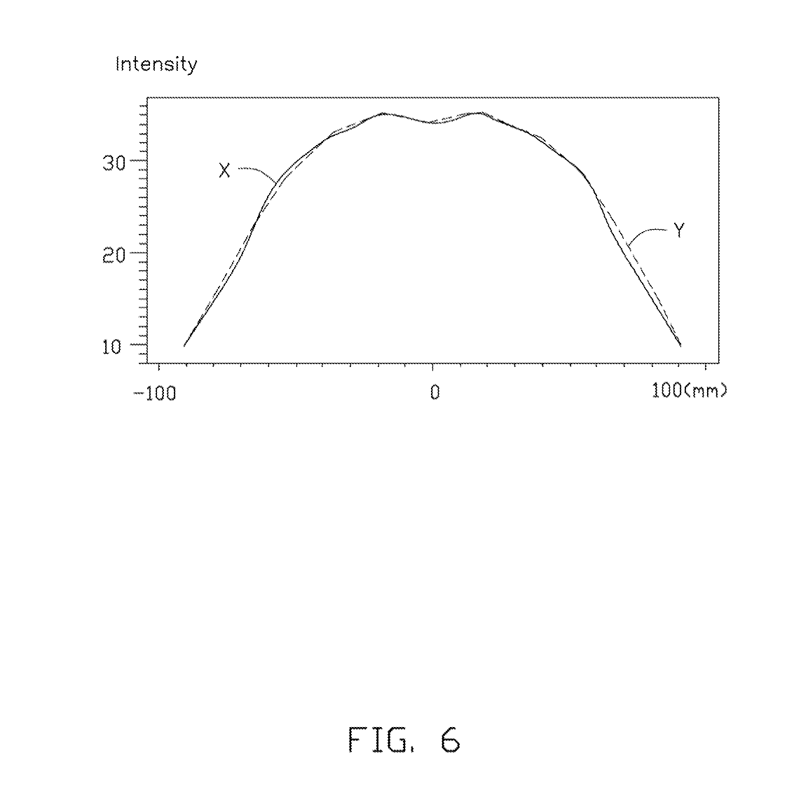

Referring to FIG. 6, different from the light intensity distribution pattern of the traditional LED light source device shown in FIG. 5, the LED light source device 10 in the present disclosure has a uniform light intensity distribution due to an enhanced light intensity in an annular region around a center of the compound lens 1. In the present embodiment, the incident light that has an incident angle θ larger than the critical angle θ0 for total reflection at the interface between the first lens 2 and the second lens 3 is reflected back into the first lens 2 due to total internal reflection.

That is to say, the incident light that has an incident angle θ in a range of the critical angle θ1 at first lens-air interface and the critical angle θ0 at first lens-second lens interface could be extracted out of the first lens 2 of the compound lens 1. In the present embodiment, the incident light that has an incident angle θ in a range of 39.57 degrees and 71.63 degrees is extracted out of the first lens 2 and passes through the second lens 3 of the compound lens 1, which could eliminate the hot spot of light intensity distribution and enhance light intensity in an annular region around a center of the compound lens 1, thus the LED light source device 10 having a uniform light intensity distribution is obtained.

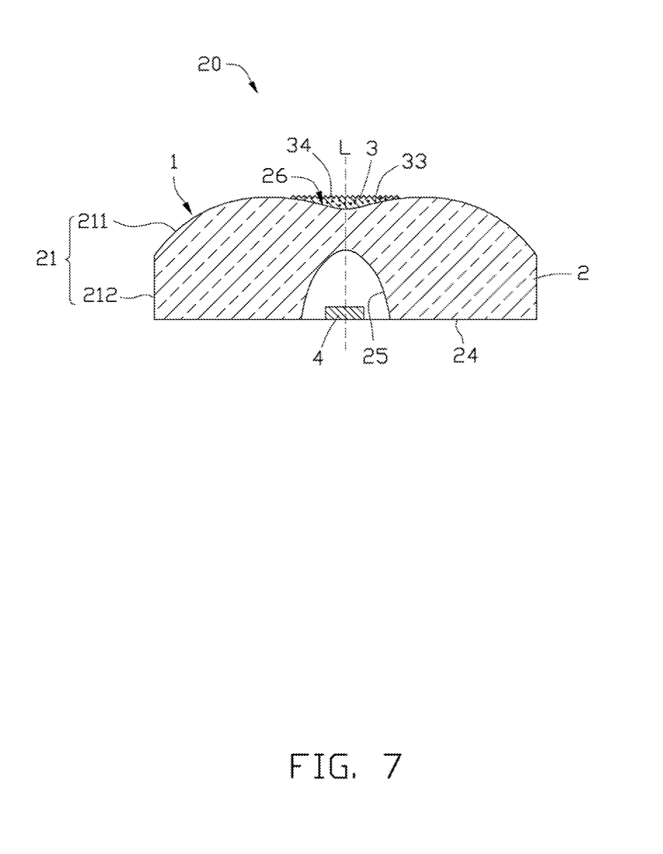

Referring to FIG. 7, different from the LED light source device 10 shown in FIG. 4, the second lens 3 of the LED light source device 20 contains phosphor particles 33 distributed therein to scatter and transfer light wavelength of the light emitted from the LED light source 4. In the present embodiment, the LED light source 4 includes a blue LED chip radiating blue light. The phosphor particles 33 are yellow phosphor particles, such as YAG phosphor particles. The phosphor particles 33 absorb blue light and re-emit yellow light, with a portion of the blue light leaking through the second lens 3. The yellow light then combines with the unconverted blue light to produce a white light.

The light exit face 31 of the second lens 3 is a foggy surface or textured to scatter light refracted into the second lens 3 of the compound lens 1. In the present embodiment, the second lens 3 defines a plurality of cutting grooves 34 in the light exit face 31 to enhance light scattering effect of the compound lens 1.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A compound lens comprising:
a first lens, the first lens comprising a light incident face and a light exit face opposite to the light incident face, and the first lens defining a recess at a center of the light exit face thereof; and
a second lens coupled to the first lens, the second lens having a refractive index lower than that of the first lens;
wherein the second lens is formed in the recess of the first lens, and a light incident face of the second lens directly contacts light exit face of the first lens.

2. The compound lens of claim 1, wherein the light exit face of the first lens is a convex surface, the light incident face of the first lens is a concave surface, and the light exit face and the light incident face of the first lens are both symmetric relative to a central axis of the first lens.

3. The compound lens of claim 2, wherein the first lens further comprises an annular mounting face interconnecting the light exit face and the light incident face thereof, and the light incident face of the first lens is recessed inwardly from an inner periphery of the annular mounting face.

4. The compound lens of claim 3, wherein the light exit face of the first lens comprises a first cylindrical face extending upwardly from an outer periphery of the annular mounting face and a second convex face bending inwardly from a top periphery of the first cylindrical face, and the recess of the first lens is located in the center of the second convex face of the light exit face of the first lens.

5. The compound lens of claim 2, wherein a distance between the light exit face and the light incident face of the first lens increases firstly and then gradually decreases along a direction from a periphery of the light exit face of the first lens to a center of the light exit face of the first lens.

6. The compound lens of claim 2, wherein a light exit face of the second lens is connected to the light incident face of the second lens, and the light exit face of the second lens is coplanar with a top portion of the light exit face of the first lens.

7. The compound lens of claim 6, wherein a distance between the light exit face of the second lens and the light incident face of the second lens gradually decreases along a direction from a center of the light exit face of the first lens to a periphery of the light exit face of the first lens.

8. The compound lens of claim 6, wherein the light exit face of the second lens is a foggy surface or textured.

9. The compound lens of claim 2, wherein the second lens contains a plurality of phosphor particles distributed therein.

10. A light source device, comprising:
a light emitting diode light source and a compound lens coupled to the light emitting diode light source;
the compound lens comprising:
a first lens, the first lens comprising a light incident face and a light exit face opposite to the light incident face, wherein the first lens defines a recess at a center of the light exit face thereof;
a second lens coupled to the first lens, the second lens having a refractive index lower than that of the first lens, wherein the second lens is formed in the recess of the first lens and a light incident face of the second lens directly contacts the light exit face of the first lens; and
wherein the light emitting diode light source faces towards the light incident face of the first lens of the compound lens.

11. The light source device of claim 10, wherein the light exit face of the first lens is a convex surface and the light incident face of the first lens is a concave surface, and the light exit face and the light incident face of the first lens are symmetric about a common central axis extending through the first lens.

12. The light source device of claim 11, wherein the first lens further comprises an annular mounting face interconnecting the light exit face and the light incident face thereof, and the light incident face of the first lens is recessed inwardly from an inner periphery of the annular mounting face.

13. The light source device of claim 12, wherein the light exit face of the first lens comprises a first cylindrical face extending upwardly from an outer periphery of the annular mounting face and a second convex face bending inwardly from a top periphery of the first cylindrical face, and the recess of the first lens is located in the center of the second convex face of the light exit face of the first lens.

14. The light source device of claim 13, wherein the annular mounting face of the first lens and the incident face of the first lens cooperatively define a receiving space to receive the light emitting diode light source therein.

15. The light source device of claim 11, wherein a distance between the light exit face and the light incident face of the first lens increases firstly and then gradually decreases along a direction from a periphery of the light exit face of the first lens to a center of the light exit face of the first lens.

16. The light source device of claim 11, wherein a light exit face of the second lens is connected to the light incident face of the second lens, and the light exit face of the second lens is coplanar with a top portion of the light exit face of the first lens.

17. The light source device of claim 16, wherein a distance between the light exit face of the second lens and the light incident face of the second lens along a direction from a center of the light exit face of the first lens to a periphery of the light exit face of the first lens.

18. The light source device of claim 16, wherein an angle between an optical axis of the light emitting diode light source and a periphery of the ling exit face of the second lens is larger than the critical angle for total reflection at the interface between the first lens and air.

19. The light source device of claim 16, wherein the light exit face of the second lens is a foggy surface or textured.

20. The light source device of claim 11, wherein the second lens contains the phosphor particles distributed therein.
